(19) United States
(12) Patent Application Publication
(10) Pub. No.: US 2013/0119956 A1
(43) Pub. Date: May 16, 2013

(54) CONTROL IC HAVING AUTO RECOVERY CIRCUIT, AUTO RECOVERY CIRCUIT OF CONTROL IC, POWER CONVERTER SYSTEM AND METHOD FOR AUTO RECOVERING CONTROL IC

(71) Applicant: Samsung Electro-Mechanics Co., Ltd., Gyeonggi-do (KR)

(72) Inventors: Hwan Cho, Gyeonggi-do (KR); Jung Chul Gong, Seoul (KR)

(73) Assignee: SAMSUNG ELECTRO-MECHANICS CO., LTD., Gyeonggi-do (KR)

(21) Appl. No.: 13/672,452

(22) Filed: Nov. 8, 2012

(30) Foreign Application Priority Data
Nov. 11, 2011 (KR) 10-2011-0117762

(51) Int. Cl. G05F 5/00; G05F 1/46

(52) U.S. Cl. CPC G05F 5/00; G05F 1/468
USPC 323/283; 327/530

(57) ABSTRACT

The present invention relates to a control IC, an auto recovery circuit, a power converter system and a method for an auto recovering. In one embodiment, there is proposed to a control IC including: an abnormal state detection unit; a protection unit changing into a protection mode in an abnormal state and changing the protection mode into an operation mode by receiving an auto recovery signal; an IC power unit receiving the power from an input power when an IC power drops until a preset low voltage under the protection mode, blocking a power supply from the input power when the IC power reaches a preset high voltage and repeating a power supplying and blocking; and an auto restart unit counting clocks alternatively repeating a power supply signal and a supply block signal and supplying the auto recovery signal when the number of counts reaches a preset value.

### CROSS-REFERENCE TO RELATED APPLICATIONS

Claim and incorporate by reference domestic priority application and foreign priority application as follows:

### Cross Reference to Related Application

This application claims the benefit under 35 U.S.C. Section 119 of Korean Patent Application Serial No. 10-2011-0117762, entitled filed Nov. 11, 2011, which is hereby incorporated by reference in its entirety into this application.

### BACKGROUND OF THE INVENTION

1. Field of the Invention

The present invention relates to a control IC having an auto recovery circuit, an auto recovery circuit of a control IC, a power converter system and a method for an auto recovering control IC. More particularly, the present invention relates to a control IC having an auto recovery circuit capable of being automatically recovered without a preliminary power, an auto recovery circuit of a control IC, a power converter system and a method for an auto recovering control IC.

2. Description of the Related Art

A control IC applied to an SMPS or the like, e.g., in case of a PWM control IC, performs an operation with a protection mode in order to protect a system and an IC by detecting an abnormal state such as an over voltage, an over current, an input low voltage, an over load, a high temperature or the like. If entering the protection mode due to a temporal abnormal state, a noise or the like, the IC allows the system to operate normally by performing a normal operation again after a predetermined time.

A conventional method is provided with a preliminary power for the operation of a PWM control IC, the protection mode function is operated during an abnormal state generation such as an over voltage, an over current or the like, the abnormal state is finished, and then the PWM control IC is automatically recovered. At this time, if the abnormal state is generated, the supply to the PWM control IC of the preliminary power is blocked by turning off a switch using the protection mode signal; and, accordingly, the control IC does not operate. And, the preliminary power is supplied to the PWM control IC again by turning on the switch after a predetermined time delay by continuing the protection mode signal during a constant time. According to the re-supply of preliminary power, the control IC can normally operate again.

That is, in case of the conventional method, the preliminary power must be required. Accordingly, it can increase the cost and cannot perform the auto recovery with only the PWM control IC without the preliminary power.

### SUMMARY OF THE INVENTION

The present invention has been invented in order to overcome the above-described problems and it is, therefore, an object of the present invention to allow a control IC to perform an operation for an auto recovery except the output in a protection mode without a preliminary power and to automatically operate in normal after a predetermined time.

In accordance with one aspect of the present invention to achieve the object, there is provided a control IC having an auto recovery circuit including: an abnormal state detection unit for detecting an abnormal state of a system or a control IC; a protection unit changing into the state of a protection mode according to the detection of the abnormal state and changing the protection mode into an operation mode by receiving an auto recovery signal in the protection mode state; an IC power unit for receiving a power at a secondary side auxiliary winding of the system in a normal state, for receiving the power from an input power of the system according to a power supply signal when an IC power drops until a preset low voltage under the protection mode state in which a power supply is stopped at the auxiliary winding, for blocking a power supply from the input power according to a supply block signal when the IC power reaches a preset high voltage after a power is supplied from the input power and for repeating a power supplying and blocking from the input power under the protection mode; and an auto restart unit for counting clocks in which the power supply signal and the supply block signal are alternatively repeated according to the protection mode start and for supplying the auto recovery signal to the protection unit when the number of counts reaches a preset value.

In another example of the present invention, the abnormal state detection unit detects at least any one of an over voltage, an over current, an over load, a thermal shutdown and a brown out.

And also, in one example, the protection unit includes a latch circuit to input an output of the abnormal state detection unit and the auto recovery signal.

And also, in one example, the IC power unit receives the power from the input power of the system early and receives the power from the secondary side auxiliary winding of the system while the power supply is blocked from the input power when it reaches the preset high voltage.

And also, in one example, the IC power unit blocks the power supply from the input power when the IC power reaches the preset high voltage in case when the protection mode is changed into the operation mode and restarts the power supply from the secondary side auxiliary winding of the system while the power supply is blocked from the input power.

And also, in one example, the auto restart unit includes: a counter for counting the clocks of the power supply signal and the supply block signal; and an AND gate for an output signal of the counter and a signal of the clocks.

And also, in one example, the auto recovery circuit is a control IC chip to drive a power transistor switch of a power converter.

At this time, the control IC includes: a PWM generation unit for generating a PWM control signal by feedback receiving a secondary side output of the system; and a driving unit for driving the power transistor switch according to a control signal generated in the PWM generation unit.

And also, in one example, the control IC includes: a PWM generation unit includes: a PWM comparator for determining a duty of the PWM control signal by using a feedback signal to feedback receive the secondary side output of the system and a detection signal of an inductor current of the system, or by using an inner voltage signal defined according to a preset status and the detection signal of the inductor current; and a NOR gate for outputting the PWM control signal by receiving an output of the PWM comparator and an output of the protection unit.

Thereafter, in order to solve the above-described problems, in accordance with the second aspect of the present invention, there is provided an auto recovery circuit of a control IC which automatically recovers from a protection mode according to an abnormal state generation of a system or the control IC to an operation mode including: an abnormal state detection unit for detecting an abnormal state; a protection unit changing into the state of a protection mode according to the detection of the abnormal state and changing the protection mode into an operation mode by receiving an auto recovery signal in the protection mode state; and an auto restart unit for counting clocks under the protection mode state that the power supply is blocked from a secondary side auxiliary winding of the system to the IC power and for supplying the auto recovery signal to the protection unit when the number of counts reaches a preset value under the protection mode state, wherein the clocks alternatively repeat a power supply signal to control to receive the power from an input power of the system when the IC power drops to a preset low voltage and a supply block signal to control to block a power supply from an input power when the IC power reaches a preset high voltage after the power is supplied from the input power.

In accordance with another example of the present invention, the abnormal state detection unit detects at least any one of an over voltage, an over current, an over load, a thermal shutdown and a brown out.

And also, in one example, the protection unit includes a latch circuit to input an output of the abnormal state detection unit and the auto recovery signal.

And, in another example, the auto restart unit includes: a counter for counting the clocks of the power supply signal and the supply block signal; and an AND gate for an output signal of the counter and a signal of the clocks.

Thereafter, in order to solve the above-described problems, in accordance with the third aspect of the present invention, there is provided a power converter system including: a power transistor switch for transmitting an input power of a system with driving on and off; a transformer for outputting a direct current power through a secondary side by receiving the input power as a primary side power according to the driving of the power transistor switch and converting the received input power; a control IC to PWM control the driving of the power transistor switch according to any one of claims 1 to 6; and a feedback circuit for supplying a feedback signal to the control IC, wherein the feedback signal is obtained by feeding back a secondary side output of the transformer.

In another example of the present system, the control IC includes: a PWM generation unit for generating a PWM control signal by feeding back the secondary side output from the feedback circuit; and a drive unit for driving the power transistor switch according to a control signal generated in the PWM generation unit.

Thereafter, in order to solve the above-described problems, in accordance with the fourth aspect of the present invention, there is provided a method for auto recovering a control IC includes: changing into a protection mode according to an abnormal state detection of a system or the control IC and blocking a power supply from a secondary side auxiliary winding of the system to an IC power; receiving a power from an input power of the system according to a power supply signal when the IC power drops until a preset low voltage after a start of the protection mode, blocking a power supply from the input power according to a supply block signal when the IC power reaches a preset high voltage after a power supply from the input power and repeating a power supply from the input power and a supply block under the protection mode; counting clocks in which the power supply signal and the supply block signal are alternatively repeated and generating an auto recovery signal when the number of counts reaches a preset value; and changing from the protection mode to an operation mode according to the auto recovery mode.

In accordance with another example of the present method, the abnormal state detection unit detects at least any one of an over voltage, an over current, an over load, a thermal shutdown and a brown out.

And also, in one example, the method for auto-recovering a control IC further includes: blocking a power supply from the input power when the control IC reaches a preset high voltage with receiving a power from an input power of the system early before the protection mode start, and receiving a power from a secondary side auxiliary winding of the system.

And also, in accordance with one example, in the changing from the protection mode to an operation mode, a power supply is blocked from the input power when the IC power reaches the preset high voltage and a power supply is restarted from a secondary side auxiliary winding of the system.

In another example, the control IC is a PWM control chip to drive a power transistor switch of a power converter.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram schematically showing a control IC having an auto recovery circuit in accordance with one embodiment of the present invention;

FIG. 2 is a block diagram schematically showing a control IC having an auto recovery circuit in accordance with another embodiment of the present invention;

FIG. 3 is a block diagram schematically showing a control IC having an auto recovery circuit in accordance with another embodiment of the present invention;

FIG. 4 is a block diagram schematically showing a control IC having an auto recovery circuit in accordance with another embodiment of the present invention;

FIG. 5 is a graph schematically showing an operation for auto-recovering a control IC in accordance with another embodiment of the present invention;

FIG. 6 is a graph schematically showing a normal operation state of a power supply of a control IC having an auto recovery circuit in accordance with another embodiment of the present invention;

FIG. 7 is a block diagram schematically showing a power converter system in accordance with another embodiment of the present invention;

FIGS. 8a and 8b are flow charts schematically showing a method for auto-recovering a control IC in accordance with another embodiment of the present invention; and

FIG. 9 is a flow chart schematically showing a method for auto-recovering a control IC in accordance with another embodiment of the present invention.

### DETAILED DESCRIPTION OF THE PREFERABLE EMBODIMENTS

Hereinafter, embodiments of the present invention to achieve the above-described objects will be described with reference to the accompanying drawings. In the present description, like numerals refer to like elements throughout the description of the drawings and parts not relating to the description may be omitted to clearly describe the present invention.

In the present specification, if there is no limitation of “direct” in relations that one element is connected, coupled or arranged to the other elements; they may exist in shapes of “direct connection, couple or arrangement” as well as connection, couple or arrangement by inserting another element therebetween. And also, the terms representing “contact” such as “on”, “above”, “bottom”, “below” or the like are also similar. In case when the element being a reference is inverted or the direction thereof is changed, it will be interpreted that the relative direction concepts corresponding thereto are implicated.

In this specification, the singular form includes the plural form unless the context clearly indicates otherwise. Further, terms “comprises” and/or “comprising” used herein specify the existence of described components, steps, operations, and/or elements, but do not preclude the existence of addition of one or more other components, steps, operations, and/or elements.

Hereinafter, the reference numerals which are not shown in the drawings referred to the detailed description respectively may be the reference numerals shown in the other drawings including the same constructions.

At first, the control IC having the auto recovery circuit in accordance with a first embodiment of the present invention will be described in detail with reference to the accompanying drawings.

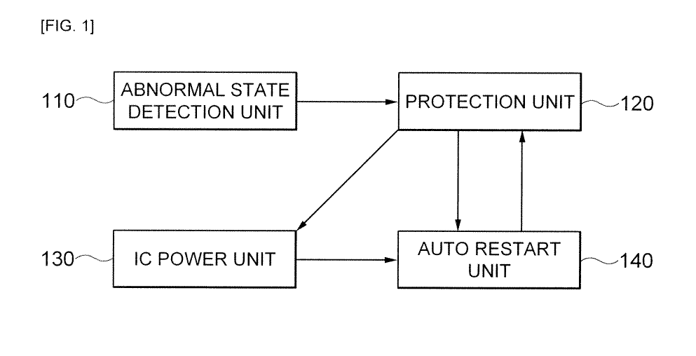

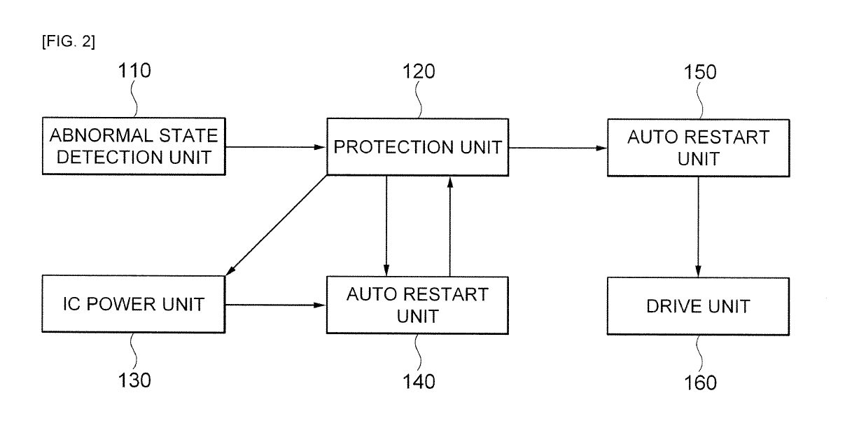

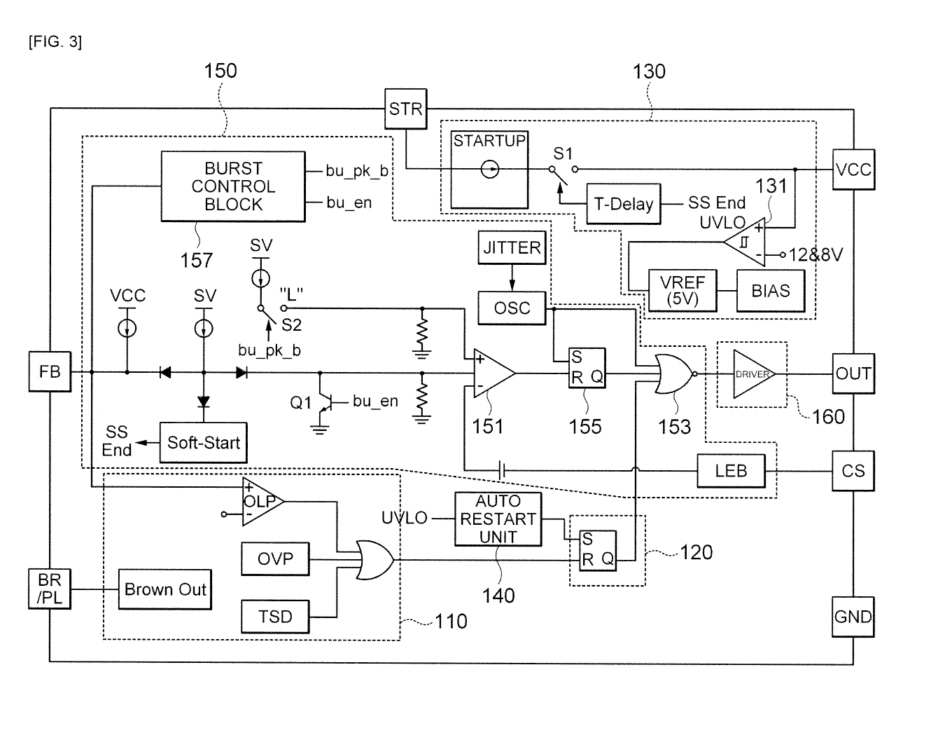

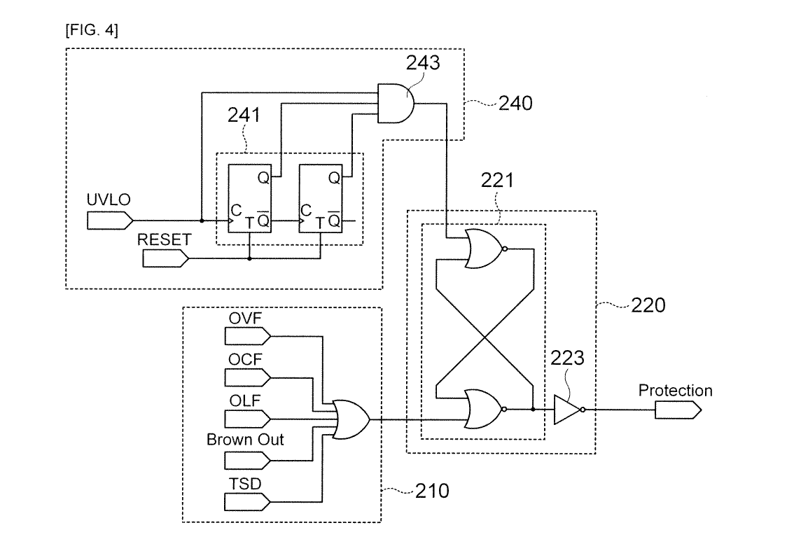

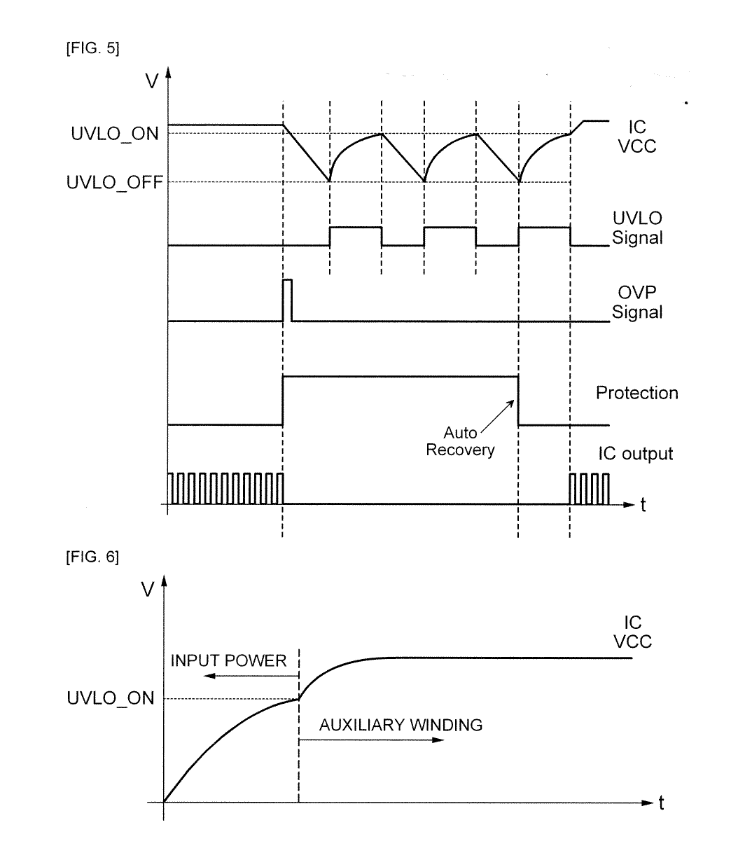

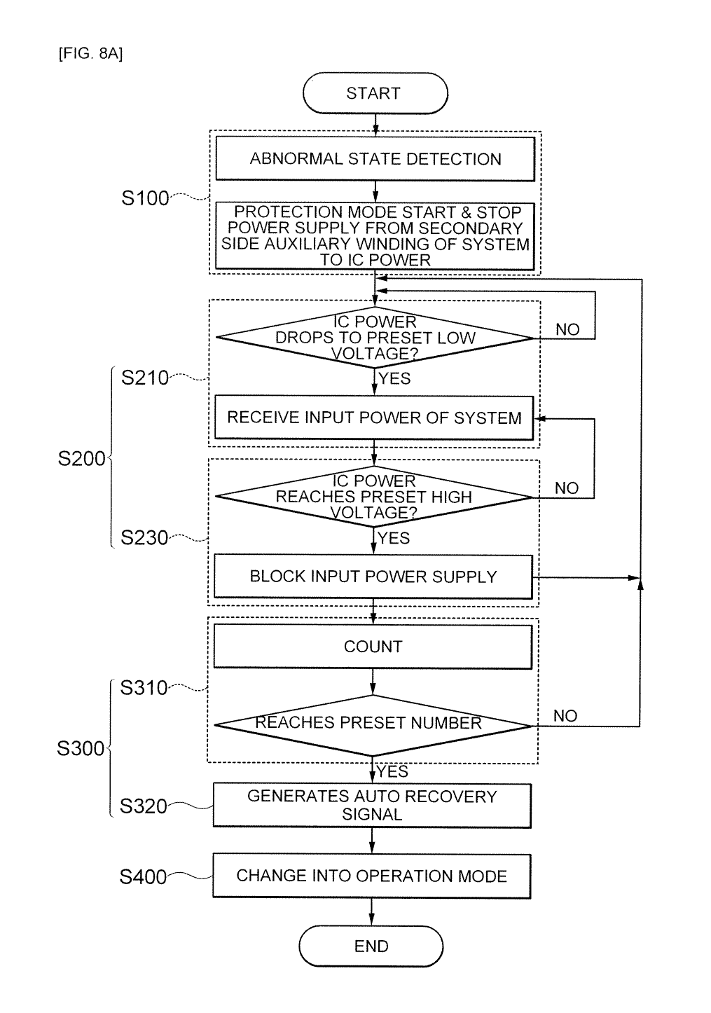

FIG. 1 is a block diagram schematically showing a control IC having an auto recovery circuit in accordance with one embodiment of the present invention. FIG. 2 is a block diagram schematically showing a control IC having an auto recovery circuit in accordance with another embodiment of the present invention. FIG. 3 is a block diagram schematically showing a control IC having an auto recovery circuit in accordance with another embodiment of the present invention. FIG. 4 is a block diagram schematically showing a control IC having an auto recovery circuit in accordance with another embodiment of the present invention. FIG. 5 is a graph schematically showing an operation for auto-recovering a control IC in accordance with another embodiment of the present invention and FIG. 6 is a graph schematically showing a normal operation state of a power supply of a control IC having an auto recovery circuit in accordance with another embodiment of the present invention;

Referring to FIG. 1, the control IC having the auto recovery circuit in accordance with the first embodiment of the present invention includes an abnormal state detection unit 110, a protection unit 120, an IC power unit 130 and an auto restart unit 140.

In FIG. 1, the abnormal state detection unit 110 detects an abnormal state of a system having the control IC or the control IC in accordance with the embodiment. The abnormal state means that a state deviates from a normal state, for example, may be an over-voltage, an over-current, an over load, an input low voltage, a thermal shutdown or the like. As OLP, OVP and TSD shown in FIG. 3 and OCP, Brown Out or the like shown in FIG. 4 mean the detection modes for each of the abnormal states, the OLP is an over load protection, the OVP is an over-voltage protection, the TSD is a thermal shutdown and the OCP is an over-current protection. For example, the OLP, the OCP and the Brown Out may represent the abnormal states. For example, as shown in FIG. 3 and FIG. 4, the abnormal state detection units 110 and 210 may be implemented by each of the abnormal state detection mode and an OR gate. In FIG. 5, the OVP signal is shown as an example of the abnormal state detection signal.

As one example, the abnormal state detection unit 110 can detect at least one among the over-voltage, the over-current, the over load, the input low voltage, the thermal shutdown and the brown out.

Thereafter, the protection unit 120 of FIG. 1 changes an operation mode state into a protection mode according to the detection of the abnormal state in the abnormal state detection unit 110. Referring to FIG. 5, there is shown that the protection signal is activated as the abnormal state detection signal, i.e., OVP signal, is generated. The protection mode is proceeded during a period that the protection signal of FIG. 5 is a high state. Referring to FIG. 5, an output of the control IC does not exist during a period that at least one protection mode proceeds. And also, in the protection mode state of the present embodiments, the IC VCC as an IC power repeats the rising and the falling between a UVLO_ON as a preset high voltage and a UVLO_OFF as a preset low voltage.

For example, as shown in FIG. 3 and FIG. 4, if an abnormal state such as the OVP is inputted into the protection units 120 and 220 through the abnormal state detection units 110 and 210, the protection units 120 and 220 stop the output of the control IC and the operation of the system by using a latch protection in order to protect the control IC and the system. If becomes the protection mode state, the IC VCC repeats the rising and the falling between the UVLO_ON and the UVLO_OFF as shown in FIG. 5, it allows the control IC to be operated normally by resetting the latch protection, for example, as shown in FIG. 4, by sensing and counting the UVLO signal according to this.

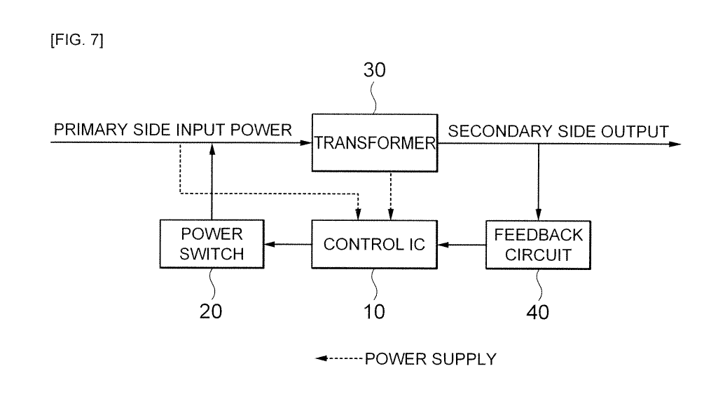

The protection unit 120 of FIG. 1 changes the auto recovery signal into an operation mode under the state of protection mode. Referring to FIG. 5, for example, at the time when the UVLO signal is changed into the third high, that is, the protection signal is changed into a low state by the auto recovery signal at the third clock edge rising time to finish. As shown in FIG. 5, if the protection signal is changed into a low state and becomes to be an operation mode, since the IC VCC as the IC power receives the power from the input power of the system since the UVLO signal is the high state. For example, in FIG. 5, although the operation mode proceeds, the control IC still does not reach the normal state; and, accordingly, the output of the control IC is not recovered immediately according to the restart of the operation mode. Subsequently, referring to FIG. 5, according to the proceeding of the operation mode, for example, if the IC power reaches the time when it reach the UVLO_ON voltage as a preset high voltage as the time when the control IC becomes the normal state, the UVLO signal changes into the low state and the power supply from the input power(not shown) of the system, since the control IC reaches the normal state, the output of the control IC restarts; and, accordingly, the power is supplied from an auxiliary winding(not shown) of a secondary side of a transformer(referring to reference numeral 30 of FIG. 7) of the system.

Since the protection unit 120 of FIG. 5 changes the protection mode into the operation mode according to the input signal, for example, it can be provided with a latch circuit 12O or 221 of FIG. 3 and/of FIG. 4. In the present embodiments, if becoming the protection mode state, although the control IC itself operates, but, as shown in FIG. 5, the output signal in the control IC, for example, since the driving signal for the power transistor (not shown) is not outputted, the power is not supplied from the auxiliary winding (not shown) of the secondary side of the transformer (referring to the reference numeral 30 of FIG. 7) of the system in the following IC power unit 130. For example, referring to FIG. 5, after changing from the protection mode to the operation mode, the control IC becomes the normal state as the IC power reaches the UVLO_ON voltage as the preset high voltage after a predetermined time pass, and the IC power unit 130 receives the power from the secondary side auxiliary winding (not shown) of the system. Or, differently from as shown in FIG. 5, the output of the control IC restarts immediately at the time when the protection mode is changed into the operation mode; and, accordingly, the IC power unit 130 can supply the power from the secondary side auxiliary winding of the system. For example, in case when the auto recovery signal as the auto recovery signal of FIG. 5 is generated at the time of a falling clock edge of the UVLO signal different from as shown, since the IC power reaches the UVLO_ON voltage as the IC VCC is previously set as a high voltage, the output of the control IC restarts; and, accordingly, the IC power unit 130 can receive the power from the secondary side auxiliary winding (not shown) of the system. Or, different from as shown in FIG. 5, although the IC VCC does not reach the UVLO_ON voltage as the previously set high voltage, the output of the control IC may restart at the time when the protection signal becomes the low state and is changed into the operation mode.

For example, as one example, as shown in FIG. 3 and FIG. 4, the protection units 120 and 220 can include the latch circuits 120 and 121 to receive the outputs of the abnormal state detection units 110 and 210 and the auto recovery signals as an input from the auto restart units 140 and 240. In FIG. 3, the latch circuit 120 receives the output of the abnormal state detection unit 110 as a reset input R and the auto recovery signal of the auto restart unit 140 as a set signal S to output those in an output terminal Q̅ and, in the FIG. 4, there is shown that the protection unit 220 includes the latch circuit 221 and an inverter 223. At this time, the latch circuit 221 of FIG. 4 outputs inversely through the inverter 223 after receiving the output of the abnormal state detection units 110 and 210 as the set input S and the auto recovery signal of the auto restart unit 140 as the reset input S to be outputted in the output terminal Q.

Thereafter, the power supply unit 130 of FIG. 1 receives the power from the secondary side auxiliary winding (not shown) of the system, for example, the secondary side auxiliary winding of the transformer (referring to the reference numeral 30 of FIG. 7) of the power converter system, under the normal state. In the present specification, the normal state may be different from the operation mode. The normal state means the stable state of the system during the operation with the operation mode state in place of the protection mode. Therefore, it may be the normal state in case under the operation mode state, but it may be the operation mode before reaching the normal state. If it can be changed into the protection mode by detecting the abnormal state, the power supply is stopped to the IC power from the secondary side auxiliary winding.

For example, the IC power unit 130 can include a capacitor (not shown) at an outside of a terminal connected to the secondary side auxiliary winding (not shown). Accordingly, in the normal state, the IC power unit 130 charges the power supplied from the secondary side auxiliary winding to the capacitor formed at the outside of the terminal and the power charged at the capacitor can be used as the IC power in case when the power supply is stopped from the secondary side auxiliary winding according to the start of the protection mode. At this time, the auto recovery time can be varied according to the capacitance of the IC power capacitor, i.e., VCC capacitor (not shown).

The IC power unit 130 of FIG. 1 receives the power from the input power of the system according to the power supply signal when the IC power drops until a preset low voltage, e.g., the UVLO_OFF voltage of FIG. 5, under the state of protection mode. The power supply signal, e.g., the high signal of the UVLO signal in FIG. 5, is a control signal to receive the power from the input power of the system. For example, if the control IC or the system becomes the abnormal state such as an OVP, an OCP, an OPL, a brown out, a TSD or the like, as shown in FIG. 5, the output is stopped with stopping the operation of the control IC; and, accordingly, the power supply is stopped from the secondary side auxiliary winding of the transformer (referring to the reference numeral 30 of FIG. 7) of the system. Then, for example, the supply voltage (the IC VCC of FIG. 5) of the control IC becomes reduced from the IC power capacitor, e.g., the VCC capacitor (not shown). At this time, if the supply voltage (the IC VCC of FIG. 5) of the control IC drops to the preset low voltage UVLO_OFF, the power supply starts from the input power of the system.

Subsequently, under the state of protection mode, the IC power unit 130 blocks or stops the power supply from the input power (not shown) according to the supply block signal in case when the IC power reaches the preset high voltage, e.g., the UVLO_ON voltage of FIG. 5, after the power supply from the input power of the system. At this time, the supply block signal, e.g., the low signal of the UVLO signal in FIG. 5, is a control signal to block the power supply from the input power of the system in case when the IC power reaches the preset high voltage, e.g., the UVLO_ON voltage of FIG. 5, according to the power supply from the input power of the system. In FIG. 5, if the power supply is restarted from the input power of the system, although the supply voltage (the IC VCC of FIG. 5) of the control IC reaches the UVLO_ON and the power supply is stopped from the input power of the system again, the power supply is not implemented at the secondary side auxiliary winding of the system since the control IC is the protection state. Therefore, the supply voltage of the control IC becomes reduced and the rising and the falling operations of the IC VCC as shown in FIG. 5 are repeated.

Explaining with reference to FIG. 3, according to the start of protection mode, since the secondary side auxiliary winding (not shown) of the system connected through the VCC terminal of FIG. 3 does not have the output, for example, the voltage of the IC power charged at the capacitor (not shown) connected to the secondary side auxiliary winding in parallel at an outside of the VCC terminal drops gradually and inputs into a UVLO comparator. In the UVLO comparator, in case when the voltage of the IC power drops to the UVLO_OFF voltage (8V in FIG. 3) as the preset low voltage, the switch S1 is conducted again and the power is supplied from the input power of the system through the STR terminal according to the driving of the switch S1. In case when the current source STARTUP supplied from the input power of the system through the STR terminal reaches the UVLO_ON voltage (12V in FIG. 3) as the preset high voltage in the UVLO comparator, the VREF of 5V drives a soft start circuit of FIG. 3 and blocks the power supply of the input power of the system through the STR terminal with allowing the SS_End signal outputted in the soft start circuit to open the switch S1 through a T-Delay.

Referring to FIG. 5, the power unit 130 of FIG. 1 repeats the power supply and the supply block from the input power (not shown) of the system according to the repeat of the power supply signal and the supply block signal, e.g., the repeat of the high and low signals of the UVLO signal of FIG. 5. At this time, the repeat number of the power supply and block from the input power of the system may be determined based on a setting status. If the power supply and block are repeated until the set number, an auto recovery signal is supplied to the protection unit 120 in the following auto restart unit 140. In FIG. 5, there is shown that the protection mode is finished by changing the protection signal into low by generating an Auto Recovery signal as the auto recovery signal at the time when the high clock of the UVLO signal is generated.

Referring to FIG. 6, reviewing one example, it can be operated without an additional backup power supply different from the prior art. Referring to FIG. 6, while the IC power unit 130 of FIG. 1 receives the power from the input power (not shown) of the system having the control IC of the present invention at an early stage, the power supply is blocked or stopped from the input power of the system, when the supply power of the control IC reaches the preset high voltage UVLO_ON as a constant voltage, and the power is supplied from the secondary side auxiliary winding (not shown) of the system.

Reviewing in detail, the IC power unit 130 receives the input power of the system having the control IC of the present invention, e.g., an input power in the SMPS or an input power such as a primary side input power of the transformer (referring to the reference numeral 30 of FIG. 7) in the SMPS until reaching the early preset high voltage, e.g., the UVLO_ON voltage shown in FIG. 6. Referring to FIG. 3, by receiving, e.g., the input power in the SMPS or the input power such as the primary side input power of the transformer (referring to the reference numeral 30 of FIG. 7) in the SMPS through the STR terminal at an early stage, it is supplied to a BIAS through the switch S1 as a STARTUP current source. Referring to FIG. 3, although the STARTUP current source is supplied to the BIAS before reaching the UVLO_ON voltage (12V in FIG. 3) by being inputted into the UVLO comparator, the normal system is operated when reaching the UVLO_ON voltage (12V in FIG. 3), the switch Si is opened and the STARTUP current source is blocked after constructing a predetermined time delay (the SS_End and the T-delay in FIG. 3). At this time, the power is supplied from the secondary side auxiliary winding of the transformer (referring to the reference numeral 30 of FIG. 7) of the system through the VCC terminal of FIG. 3. In the one example, the UVLO_ON voltage as the preset high voltage may be a voltage that the control IC reaches the normal state. That is, the IC power unit 130 blocks the input power supply from the system when becoming the normal state at the early operation mode state, and the power can be supplied from the secondary side auxiliary winding of the transformer (referring to the reference numeral 30 of FIG. 7) of the system.

Reviewing one example with reference to FIG. 5, the IC power unit 130 blocks the power supply from the input power (not shown) when the IC power reaches the preset high voltage, e.g., the UVLO_ON voltage of FIG. 5, when it changes from the protection mode to the operation mode, and restarts the power supply from the secondary side auxiliary winding (not shown) of the system. In FIG. 5, if the protection mode is changed into the operation mode, the power is supplied form the input power of the system while the UVLO signal is a high state, the power supply is blocked when the IC VCC as the IC power reaches the UVLO_ON as the preset high voltage, but the control IC becomes the normal state as reaching the UVLO_ON voltage and the output of the control IC is restarted. Accordingly, the IC power unit 130 receives the power from the secondary side auxiliary winding (not shown) of the transformer (referring to the reference numeral 30 of FIG. 7) of the system.

And also, unlike as shown in FIG. 5, the output of the control IC restarts immediately at the time when the protection mode is changed into the operation mode. Accordingly, the IC power unit 130 may receive the power from the secondary side auxiliary winding of the system.

Thereafter, the auto restart unit 40 of FIG. 1 counts the clocks alternatively repeating the power supply signal and the supply block signal of the IC power unit 130 according to the protection mode start. And also, the restart unit 140 of FIG. 1 supplies the auto recovery signal to the protection unit 120 when the number of counts reaches a preset value. Referring to FIG. 5, the protection mode is finished by allowing the protection signal to be changed into the low by generating the auto recovery signal as the auto recovery signal at the time when the high clock of the UVLO signal is generated three times. At this time, in FIG. 5, the high signal of the UVLO signal is the power supply signal to receive the power again from the input power (not shown) of the system and the UVLO low signal is the supply block signal to block the power supply from the input power of the system. At this time, the repeat numbers of the power re-supply and re-block from the input power of the system may be determined according to the setting in the IC power unit 130.

And also, referring to FIG. 4, one example will be reviewed. Although FIG. 4 shows the auto recovery circuit of the control IC in accordance with the second embodiment, the constructions shown in FIG. 4 may be equally applied to the constructions of the control IC having the auto recovery circuit in accordance with the first embodiment of the present invention.

Referring to FIG. 4, the auto restart unit 240 can include a counter 241 and an AND gate 243. The counter 241 counts the power supply signal and the supply block signal in the IC power unit 130. At this time, the clock count can be performed by a method of counting the rising edges or the falling edges. For example, the counter 241 may count only the high clocks of the UVLO signal as the power supply signal so as to receive again the power from the input power (not shown) of the system. The AND gate 243 of FIG. 4 outputs the logic sum of the output signal of the counter 241 and the signal of clocks. For example, referring to FIG. 5, the auto recovery signal is outputted at time when the high clock of the UVLO signal as the power supply signal in the IC power unit 130. Referring to FIG. 4, the counter 241 can be formed by connecting a plurality of flip-flops. For example, as shown in FIG. 4, the UVLO signal uses as a clock in the first flip-flop, the output of Q̅ of the first flip-flop uses as a clock of the second flip-flop, and the RESET signal can be used as an input signal of the T input terminal in two flip-flops. For example, the input of the input power of the system inputted according to the high clock of the UVLO signal of FIG. 5 may be employed as the RESET signal of FIG. 4. As FIG. 4 exemplarily explains the counter 241, the counter 241 can be constructed by using various methods which are not shown in FIG. 4.

And also, in one example of the present invention, the control IC may be a PWM chip to drive a power transistor switch (referring to the reference numeral 20 of FIG. 7) of the power converter system. For example, the power converter system may be a power converter to be applied to the SMPS. Referring to FIG. 2 and FIG. 3, the present invention will be further explained.

Referring to FIG. 2 and/or FIG. 3, in one example, the control IC can further include a PWM generation unit 150 and a drive unit 160. The PWM generation unit 150 generates the PWM control signal by feeding back the secondary side output of the system. For example, the PWM generation unit 150 controls the PWM duty ratio so as to obtain a desired secondary side output by comparing with the primary side input of the system by receiving the secondary side output of the transformer (referring to the reference numeral 30 of FIG. 7) of the system.

At this time, reviewing in more detail with reference to FIG. 3, in one example, the PWM generation unit 150 can include a PWM comparator and a NOR gate. Referring to FIG. 3, the PWM comparator determines the duty of the PWM control signal by using the feedback signal obtained by feeding back the secondary side output of the system and the detection signal of the inductor current of the system or by using the inner voltage signal determined according to a preset state and the detection signal of the inductor current Referring to FIG. 3, under the normal state of the control IC, the PWM comparator can determine the duty so as to obtain the desired secondary side output by comparing the feedback signal obtained by feeding back the secondary side output of the system with the primary side input, e.g., the detection signal to monitor the inductor current, of the system. In FIG. 3, the feedback signal of the secondary side output is inputted through a FB terminal to input a negative terminal of the PWM comparator, the signal detected by monitoring the inductor current is inputted to a positive terminal of the PWM comparator through a CS terminal, in this results, the duty ratio can be determined so as to obtain the desired secondary side output by being compared in the PWM comparator. And also, referring to FIG. 3, under a special condition that the control IC is not the normal state, the duty can be determined so as to obtain the desired secondary side output by comparing the inner voltage signal determined according to the preset state not the feedback signal from the secondary side output of the system with the primary side input, e.g., the detection signal to monitor the inductor current, of the system. For example, the feedback signal of the secondary side output is extracted to the ground by applying a bu_en signal as a burst active signal to the transistor Q1 at a burst control block in FIG. 3, the 5V value as an inner voltage signal determined according to the preset state by applying a bu_pk_b as a burst peak signal to a switch S2 is inputted to a negative terminal of the PWM comparator, and the duty can be determined so as to obtain the desired secondary side output by inputting the signal detected by monitoring the inductor current to the positive terminal of the PWM comparator through the CS terminal to be compared. At this time, the duty ratio can be determined while the output of the PWM comparator in FIG. 3 is inputted and outputted to the latch circuit together with an oscillator signal. In FIG. 3, the signal to determine the duty through the PWM comparator and the latch circuit is inputted to the NOR gate.

And also, the NOR gate of FIG. 3 outputs the PWM control signal by receiving the output of the PWM comparator and the output of the protection unit 120. For example, in FIG. 3, there is shown the NOR gate to receive the signal to determine the duty ratio through the PWM comparator and the latch circuit, the signal according to the protection mode or the operation mode of the protection unit 120 and the oscillator signal. In the present embodiment, the PWM control signal can be outputted by receiving the output of the PWM comparator and the output of the protection unit 120 with a different method from the example of FIG. 3.

Subsequently, in FIG. 2 and/or FIG. 3, the drive unit 160 drives the power transistor switch (referring to the reference numeral 20 of FIG. 7) according to the control signal generated in the PWM generation unit 150.

Thereafter, the auto recovery circuit of the control IC in accordance with the second embodiment of the present invention will be reviewed in more detail with reference to the drawing. In the explanation of the second embodiment of the present invention, the examples of the control IC having the auto recovery circuit in accordance with the above-described first embodiment as well as the following FIG. 4 and FIG. 5 and FIG. 1 and FIG. 3 may be referred, accordingly, the repeated explanations may be omitted.

FIG. 4 is a block diagram schematically showing a control IC having an auto recovery circuit in accordance with another embodiment of the present invention; and FIG. 5 is a graph schematically showing an operation for auto-recovering a control IC in accordance with another embodiment of the present invention.

Referring to FIG. 4, reviewing the second embodiment of the present invention, as the auto recovery circuit of the control IC is an auto recovery circuit to be automatically recovered to the operation mode from the protection mode according to the abnormal state generation of the system or the control IC, it can be formed by including an abnormal state detection unit 110, a protection unit 120 and an auto restart unit 140. For example, the control IC having the auto recovery circuit may be a PWM control chip to drive the power transistor switch of the power converter.

At first, the abnormal state detection unit 110 of FIG. 4 detects the abnormal state of the system or the control IC. For example, referring to FIG. 4, the abnormal state detection unit 110 determines whether the abnormal state is detected any one among an OVP detection mode, an OCP detection mode, an OLP detection mode, a brown out detection mode and a TSD detection mode. According to one example, the abnormal state detection unit 110 can detect at least one among an over voltage, an over current, an over load, a thermal shutdown and a brown out. The further detail description for the abnormal state detection unit 110 will be referred to the above-described first embodiment and FIG. 1, FIG. 3 and FIG. 5.

Thereafter, the protection unit 120 of FIG. 4 changes the mode from the operation mode to the protection mode state according to the detection of the abnormal state in the abnormal state detection unit 110. Referring to FIG. 5, there is shown that the protection signal is activated as the OVP signal as the abnormal state detection signal is generated. And also, the protection unit 120 receives the auto recovery signal from the auto recovery auto restart unit 140 under the protection mode state to change into the operation mode.

And also, in one example, referring to FIG. 3 and FIG. 4, the protection units 120 and 220 can include the latch circuits 120 and 221 to input the outputs of the abnormal state detection units 110 and 210 and the auto recovery signal. Referring to FIG. 4, the protection unit 220 includes the latch circuit 221 and an inverter 223, whereas in FIG. 3 only the latch circuit 120 is included.

The more detail explanation for the protection unit 120 of FIG. 4 will be referred to the above-described first embodiment and FIG. 1 and FIG. 5.

Thereafter, the auto restart unit 140 of FIG. 4 will be reviewed. The auto restart unit 140 of FIG. 4 counts the clocks alternatively repeating the power supply signal and the supply block signal under the protection mode that the power supply is stopped to the IC power in the secondary side auxiliary winding (not shown) of the system. At this time, the clock count may be performed by a method to count the rising edges or counts the falling edges. The power supply signal, e.g., the high signal of the UVLO signal in FIG. 5, is a control signal to receive the power from the input power (not shown) of the system when the IC power drops to the preset low voltage and the supply block signal, e.g., the low signal of the UVLO signal in FIG. 5, is a control signal to block the power supply from the input power when the IC power reaches the preset high voltage after supplying the power from the input power of the system. Referring to FIG. 5, under the protection mode state, the IC VCC as the IC power repeats the fallings and the risings between the UVLO_ON voltage as the preset high voltage and the UVLO_OFF voltage as the preset low voltage. At this time, the auto restart unit 140 can count the repeat number of fallings and risings of the IC VCC as the IC power.

And also, the auto restart unit 140 of FIG. 4 supplies the auto recovery signal to the protection unit 120 when the count number reaches to a preset value. Referring to FIG. 5, The protection mode is finished by changing the protection signal into the low by generating the Auto Recovery signal as the auto recovery signal at the time when the high clock of the UVLO signal as the power supply signal to receive the power from the input power of the system again generated at third.

In case when the power supply is stopped to the IC power in the secondary side auxiliary winding (not shown) of the system according to the protection mode, e.g., the power charged at the IC power capacitor, i.e., a VCC capacitor (not shown) is used as the supply power (an IC VCC of FIG. 5) of the IC power. At this time, the supply power (the IC VCC of FIG. 5) of the IC power becomes to be reduced; and, if the IC VCC drops until the UVLO_OFF voltage as the preset low voltage, the power supply from the input power of the system is restarted, accordingly, if the IC power reaches the UVLO_ON as the preset high voltage, the operation to block the power supply from the input power of the system is repeated again. If the repeat number of fallings and risings of the IC VCC is counted and the counted number reaches the preset number, the auto recovery signal is generated. At this time, the auto recovery time can be varied according to the capacitance of the IC power capacitor, i.e., the VCC capacitor, as well as the count number.

And, referring to FIG. 4, in one example, the auto restart unit 140 can include the counter 241 and the AND gate 243. The counter 241 counts the clocks of the power supply signal for the power re-supply from the input power (not shown) of the system and the supply block signal for the power supply block. At this time, the counter 241 can count the high clocks of the UVLO signal as the power supply signal so as to be received the power from the input power of the system again. The AND gate 243 of FIG. 4 outputs the logic sum for the output signal of the counter 241 and the signal of clocks. Referring to FIG. 4, the counter 241 may be formed by connecting a plurality of flip-flops and can be formed by another method. The more detailed description for the auto restart unit 140 of FIG. 4 refers to the above-described first embodiment and FIGS. 1 and 5.

Subsequently, the power converter system in accordance with the third embodiment of the present invention will be explained in detail with reference to the drawings. In reviewing the third embodiment,

The above-described first and second embodiments and FIGS. 1 to 4 and FIG. 6 as well as the following FIG. 7 will be referred; accordingly, the repeated explanations may be omitted.

FIG. 7 is a block diagram schematically showing a power converter system in accordance with another embodiment of the present invention.

Referring to FIG. 7, the power converter system in accordance with the third embodiment of the present invention can include a switch 20, a transformer 30, a control IC 10 and a feedback circuit 40. For example, the power converter system may be a resonant type DC-DC converter, but does not limit to this.

The power transistor switch 20 of FIG. 7 performs an on-off drive according to the control of the control IC and transmits the input power of the system to the primary side of the transformer 30. At this time, the power transistor switch 10 may be an nMOS transistor.

Subsequently, in FIG. 7, the transformer 30 receives the input power of the system as the primary side power according to the drive of the power transistor switch to convert and output the converted input power as a direct current power through the secondary side.

The control IC 10 of FIG. 7 PWM controls the drive of the power transistor switch 20. The control IC 10 may be the control IC according to any one among the above-described first embodiment.

Thereafter, the feedback circuit 40 feedbacks the secondary side output of the transformer 30 to supply it to the control IC 10.

Referring to FIGS. 2 and 7, in one example, the control IC 10 can include a PWM generation unit 150 to generate a PWM control signal by feeding back the secondary side output from the feedback circuit 40 and a drive unit 160 to drive the power transistor switch 20 according to the control signal generated in the PWM generation unit.

Thereafter, an auto recovery method of the control IC in accordance with the fourth embodiment of the present invention will be described in detail with reference to the drawings. In viewing the fourth embodiment of the present invention, the above-described first and second embodiments and FIGS. 1 to 4 and FIG. 6 as well as the following FIGS. 5, 8a and 9 may be referred; accordingly, the overlapped explanations may be omitted.

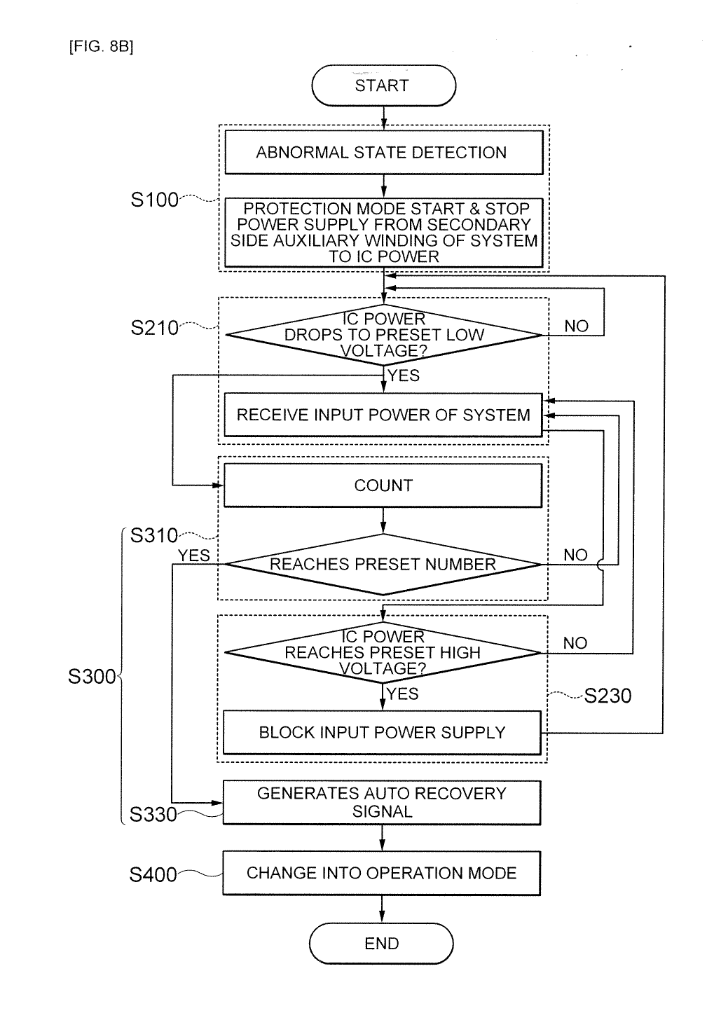

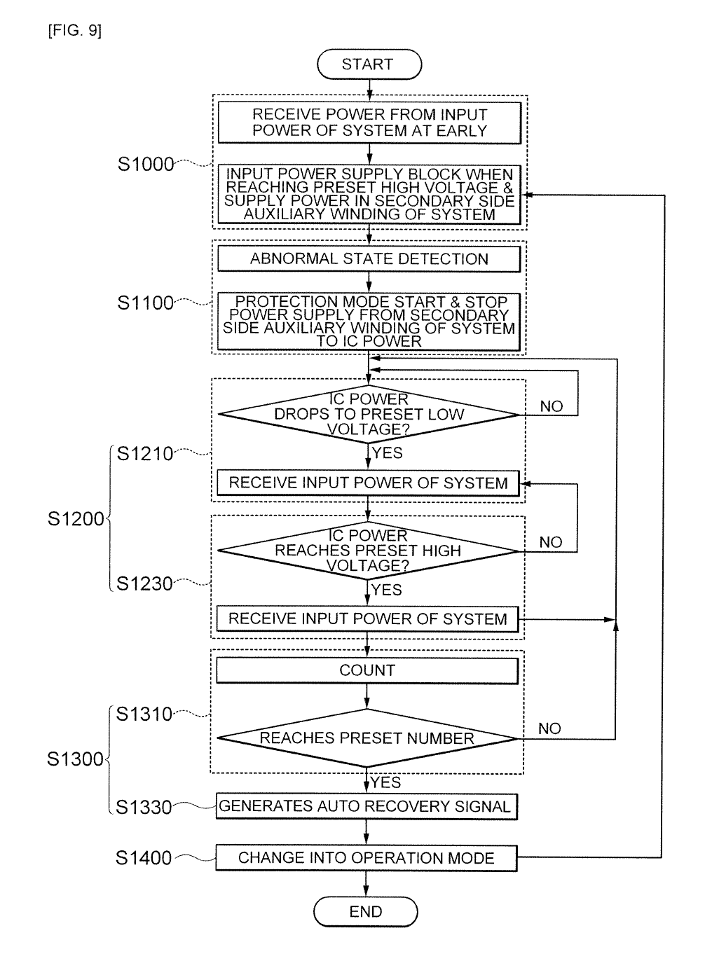

FIG. 5 is a graph schematically showing an operation for auto-recovering a control IC in accordance with another embodiment of the present invention; FIGS. 8a and 8b are flow charts schematically showing a method for auto-recovering a control IC in accordance with another embodiment of the present invention; and FIG. 9 is a flow chart schematically showing a method for auto-recovering a control IC in accordance with another embodiment of the present invention.

Referring to FIGS. 8a, 8b and 9, an auto recovery method of the control IC in accordance the third embodiment of the present invention will be reviewed. Referring to FIGS. 8a and 8b, the auto recovery method of the control IC in accordance with one embodiment is formed by including an abnormal state detection and protection mode change step S100, a power supply and block repeat from the input power of the system S200, an auto recovery signal generation step S300 and a change step S400 to the operation mode.

Meanwhile, referring to FIG. 9, the auto recovery method of the control IC in accordance with one embodiment can further include a power supply step S1000 from the secondary side auxiliary winding of the system before an abnormal state detection step S1100.

At this time, the power transistor switch of the power converter may be a PWM control chip to drive the switch.

At first, in the abnormal state detection and protection mode change step S100, changed into the protection mode according to the abnormal state detection of the system or the control IC. According to the change to the protection mode, by stopping the output of the control IC, the power supply is stopped from the secondary side auxiliary winding of the system to the IC power.

And then, according to one example, the abnormal state detection in the abnormal state detection and protection mode change step S100 may be performed by detecting any one among an over voltage, an over current, an over load, a thermal shutdown and a brown out.

Thereafter, the power supply and block repeat from the input power of the system S200 of FIG. 8a and FIG. 8b will be reviewed. In the present step S200, at first, according to the start of the protection mode, the power is supplied from the input power of the system according to the power supply signal when the IC power drops to the preset low voltage S210. And, the power supply is blocked from the input power according to the supply block signal when the IC power reaches the preset high voltage according to the power supply from the input power of the system S230. In the present step S200, the power supply and block from the input power of the system are performed repeatedly.

Referring to FIG. 5, in case when the power supply is stopped in the auxiliary winding according to the start of the protection mode and in case when the IC power drops to the preset low voltage, e.g., the UVLO_OFF of FIG. 5, the IC power receives the power from the input power again according to the power supply signal, e.g., the high signal of the UVLO signal in FIG. 5, to receive the power from the input power of the system again S210. And also, the power supply from the input power of the system to the IC power is blocked again or stopped S230 according to the supply block signal, e.g., the low signal of the UVLO signal in FIG. 5, to block the power supply from the input power of the system when the IC power reaches the preset high voltage, e.g., the UVLO_ON voltage of FIG. 5, according to the power supply form the input power of the system. Under the protection mode state, the power re-supply and re-block from the input power of the system are repeated according to the repeat of high and low signals of the UVLO signal of FIG. 5. At this time, the repeat number of the power re-supply and re-block from the input power of the system is counted to generate the auto recovery signal S310 and the repeat number can be determined according to the setting.

Thereafter, the auto recovery signal generation step S300 of FIGS. 8a and 8b will be reviewed. In the auto recovery signal generation step S300 of the present embodiment, the clocks in which the power supply signal for the power supply from the input power of the system and the supply block signal for the power supply block from the input power of the system are alternatively repeated S310. Referring to FIG. 5, the fallings and the risings between the UVLO_ON voltage as the preset high voltage of the IC VCC as the IC power and the UVLO_OFF voltage as the preset low voltage may be counted. At this time, the clock count may be performed as a method to count the rising edges or to count the falling edges. For example, referring to FIG. 5, only the high clocks of the UVLO signal as the power supply signal to receive the power again from the input power of the system can be counted S310. In FIG. 8a, there is shown that the clocks are counted as a method to count the supply block signals, e.g., the clock falling edges, in FIG. 8b, there is shown that the clocks are counted as a method to count the power supply signals, e.g., the clock rising edges. And also, although the count method is shown according to FIG. 8a, but the method of FIG. 8b may be applied.

And also, in this step S300, the auto recovery signal is generated S330 when the count number reaches the preset value. Referring to FIG. 5, the Auto Recovery signal as the auto recovery signal at the time when the high clock of the UVLO signal as the power supply sign to receive the power again from the input power of the system is generated at third.

And, in the changing step S400 to the operation mode of FIGS. 8a and 8b, the protection mode is changed into the operation mode according to the auto recovery signal generated in the above-described auto recovery signal generation step S300. Referring to FIG. 5, the Auto Recovery signal as the auto recovery signal is generated at the time when the high clock of the UVLO signal is generated at third; and, accordingly, the protection mode is finished and the operation mode is preceded by changing the protection signal into the low.

And also, according to one example, in the step S400 of being changed into the operation mode, the power supply is blocked from the input power of the system when the IC power reaches the preset high voltage, and the power supply can be restarted from the secondary side auxiliary winding of the system. For example, in order to receive the power from the secondary side auxiliary winding of the transformer (referring to the reference numeral 30 of FIG. 7) of the system not the input power of the system under the normal state of the control IC, as shown in FIG. 5, the power supply is blocked from the input power of the system when reaching the UVLO_ON voltage as the preset high voltage of the IC VCC and the power supply can be restarted from the secondary side auxiliary winding of the system.

Thereafter, referring to FIG. 9, an auto recovery method of the control IC in accordance with one example of the present invention will be reviewed. Referring to FIG. 9, the auto recovery method of the control IC in accordance with one example can further include a power supply step S1000 from the secondary side auxiliary winding before the abnormal state detection step S1100. That is, before the protection mode start, the power supply is blocked from the input power when reaching the preset high voltage with receiving the power from the input power of the system at early and the power can be supplied from the secondary side auxiliary winding of the system S1000.

In accordance with embodiments of the present invention, the present invention to allow a control IC to perform an operation for an auto recovery except the output in a protection mode without a preliminary power and to automatically operate in normal after a predetermined time.

Accordingly, the present invention can automatically recover the erroneous operations of protection modes due to noises.

And also, the present invention is capable of performing an auto recovery operation without a preliminary power.

This invention may be embodied in different forms and should not be construed as limited to the embodiments set forth herein. Rather, these embodiments are provided so that this disclosure will be thorough and complete, and will fully convey the scope of the invention to those skilled in the art. As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A control IC having an auto recovery circuit comprising:
an abnormal state detection unit for detecting an abnormal state of a system or a control IC;
a protection unit changing into the state of a protection mode according to the detection of the abnormal state and changing the protection mode into an operation mode by receiving an auto recovery signal in the protection mode state;
an IC power unit for receiving a power at a secondary side auxiliary winding of the system in a normal state, for receiving the power from an input power of the system according to a power supply signal when an IC power drops until a preset low voltage under the protection mode state in which a power supply is stopped at the auxiliary winding, for blocking a power supply from the input power according to a supply block signal when the IC power reaches a preset high voltage after a power is supplied from the input power and for repeating a power supplying and blocking from the input power under the protection mode; and
an auto restart unit for counting clocks in which the power supply signal and the supply block signal are alternatively repeated according to the protection mode start and for supplying the auto recovery signal to the protection unit when the number of counts reaches a preset value.

2. The control IC having an auto recovery circuit according to claim 1, wherein the abnormal state detection unit detects at least any one of an over voltage, an over current, an over load, a thermal shutdown and a brown out.

3. The control IC having an auto recovery circuit according to claim 1, wherein the protection unit includes a latch circuit to input an output of the abnormal state detection unit and the auto recovery signal.

4. The control IC having an auto recovery circuit according to claim 1, wherein the IC power unit receives the power from the input power of the system early and receives the power from the secondary side auxiliary winding of the system while the power supply is blocked from the input power when it reaches the preset high voltage.

5. The control IC having an auto recovery circuit according to claim 1, wherein the IC power unit blocks the power supply from the input power when the IC power reaches the preset high voltage in case when the protection mode is changed into the operation mode and restarts the power supply from the secondary side auxiliary winding of the system while the power. supply is blocked from the input power.

6. The control IC having an auto recovery circuit according to claim 1, wherein the auto restart unit includes:
a counter for counting the clocks of the power supply signal and the supply block signal; and
an AND gate for an output signal of the counter and a signal of the clocks.

7. The control IC having an auto recovery circuit according to claim 1, wherein the auto recovery circuit is a control IC chip to drive a power transistor switch of a power converter.

8. The control IC having an auto recovery circuit according to claim 7, wherein the control IC includes:
a PWM generation unit for generating a PWM control signal by feedback receiving a secondary side output of the system; and
a driving unit for driving the power transistor switch according to a control signal generated in the PWM generation unit.

9. The control IC having an auto recovery circuit according to claim 8, wherein the control IC includes:
a PWM generation unit includes:
a PWM comparator for determining a duty of the PWM control signal by using a feedback signal to feedback receive the secondary side output of the system and a detection signal of an inductor current of the system, or by using an inner voltage signal defined according to a preset status and the detection signal of the inductor current; and
a NOR gate for outputting the PWM control signal by receiving an output of the PWM comparator and an output of the protection unit.

10. An auto recovery circuit of a control IC which automatically recovers from a protection mode according to an abnormal state generation of a system or the control IC to an operation mode comprising:
an abnormal state detection unit for detecting an abnormal state;
a protection unit changing into the state of a protection mode according to the detection of the abnormal state and changing the protection mode into an operation mode by receiving an auto recovery signal in the protection mode state; and
an auto restart unit for counting clocks under the protection mode state that the power supply is blocked from a secondary side auxiliary winding of the system to the IC power and for supplying the auto recovery signal to the protection unit when the number of counts reaches a preset value under the protection mode state, wherein the clocks alternatively repeat a power supply signal to control to receive the power from an input power of the system when the IC power drops to a preset low voltage and a supply block signal to control to block a power supply from an input power when the IC power reaches a preset high voltage after the power is supplied from the input power.

11. The auto recovery circuit of a control IC according to claim 10, wherein the abnormal state detection unit detects at least any one of an over voltage, an over current, an over load, a thermal shutdown and a brown out.

12. The auto recovery circuit of a control IC according to claim 10, wherein the protection unit includes a latch circuit to input an output of the abnormal state detection unit and the auto recovery signal.

13. The auto recovery circuit of a control IC according to claim 10, wherein the auto restart unit includes:
a counter for counting the clocks of the power supply signal and the supply block signal; and
an AND gate for an output signal of the counter and a signal of the clocks.

14. A power converter system comprising:
a power transistor switch for transmitting an input power of a system with driving on and off;
a transformer for outputting a direct current power through a secondary side by receiving the input power as a primary side power according to the driving of the power transistor switch and converting the received input power;
a control IC to PWM control the driving of the power transistor switch according to claim 1; and
a feedback circuit for supplying a feedback signal to the control IC, wherein the feedback signal is obtained by feeding back a secondary side output of the transformer.

15. The power converter system according to claim 14, wherein the control IC includes:
a PWM generation unit for generating a PWM control signal by feeding back the secondary side output from the feedback circuit; and
a drive unit for driving the power transistor switch according to a control signal generated in the PWM generation unit.

16. A method for auto recovering a control IC includes:
changing into a protection mode according to an abnormal state detection of a system or the control IC and blocking a power supply from a secondary side auxiliary winding of the system to an IC power;
receiving a power from an input power of the system according to a power supply signal when the IC power drops until a preset low voltage after a start of the protection mode, blocking a power supply from the input power according to a supply block signal when the IC power reaches a preset high voltage after a power supply from the input power and repeating a power supply from the input power and a supply block under the protection mode;
counting clocks in which the power supply signal and the supply block signal are alternatively repeated and generating an auto recovery signal when the number of counts reaches a preset value; and
changing from the protection mode to an operation mode according to the auto recovery mode.

17. The method for auto-recovering a control IC according to claim 16, wherein the abnormal state detection unit detects at least any one of an over voltage, an over current, an over load, a thermal shutdown and a brown out.

18. The method for auto-recovering a control IC according to claim 16, further comprising:
blocking a power supply from the input power when the control IC reaches a preset high voltage with receiving a power from an input power of the system early before the protection mode start, and receiving a power from a secondary side auxiliary winding of the system.

19. The method for auto-recovering a control IC according to claim 16, wherein, in the changing from the protection mode to an operation mode, a power supply is blocked from the input power when the IC power reaches the preset high voltage and a power supply is restarted from a secondary side auxiliary winding of the system.

20. The method for auto-recovering a control IC according to claim 16, wherein the control IC is a PWM control chip to drive a power transistor switch of a power converter.
